(19) United States
(12) Patent Application Publication
(10) Pub. No.: US 2011/0288241 A1
(43) Pub. Date: Nov. 24, 2011

(54) DONOR-ACCEPTOR ROD-COIL DIBLOCK COPOLYMER FOR ORGANIC SOLAR CELLS AND SYNTHESIS METHOD THEREOF

(75) Inventors: Ki Hwan Oh, Seoul (KR); ChangDuk Yang, Ulsan (KR); Jin Young Kim, Ulsan (KR); MyoungHee Yun, Ulsan (KR); JongGi Kim, Ulsan (KR); Yong Jun Jang, Seongnam (KR)

(73) Assignees: UNIST ACADEMY-INDUSTRY RESEARCH CORPORATION, Ulsan (KR); HYUNDAI MOTOR COMPANY, Seoul (KR)

(21) Appl. No.: 12/880,442

(22) Filed: Sep. 13, 2010

(30) Foreign Application Priority Data
May 18, 2010 (KR) 10-2010-0046634

(51) Int. Cl. C08F 291/14; C08F 8/30; B82Y 30/00

(52) U.S. Cl. 525/376; 977/734

(57) ABSTRACT

The present invention features a donor-acceptor rod-coil diblock copolymer for an organic solar cell and a method for synthesizing the same. In certain embodiments, the present invention features a donor-acceptor rod-coil diblock copolymer for an organic solar cell based on polythiophene and fullerene and a method for synthesizing the same. Preferably, the block copolymer exhibits a nanofibrillar structure in solid film and, when added to an active layer of a bulk heterojunction organic solar cell consisting of poly(3-hexylthiophene) (P3HT) and [6,6]-phenyl-C₆₁-butyric acid methyl ester (PCBM) as a compatibilizing agent, improves efficiency and stability of the solar cell.

### CROSS-REFERENCE TO RELATED APPLICATIONS

This application claims priority under 35 U.S.C. §119 to Korean Patent Application No. 10-0046634, filed on May 18, 2010, in the Korean Intellectual Property Office, the disclosure of which is incorporated herein by reference in its entirety.

### TECHNICAL FIELD

The following disclosure relates to a donor-acceptor rod-coil diblock copolymer for an organic solar cell and a method for synthesizing the same. The block copolymer may be usefully applied as an active layer of a bulk heterojunction organic solar cell consisting of polythiophene and fullerene as a compatibilizing agent.

### BACKGROUND

Fossil energy presently being used may not be available for long because fossil energy resources are almost depleted, there being only a few tens of years of reservoir. Further, fossil energy has been indicated as one of the main suspects causing the greenhouse effect due to its increased carbon dioxide emission. Accordingly, there has been a growing interest in the development of alternative energy, and among them, solar cell has been of particular interest. An organic solar cell is a newly developed solar cell whose technical feasibility has rapidly improved in recent years. An organic solar cell refers to a complex-structure solar cell using an organic semiconductor material such as semiconducting polymers or photosensitive small molecule derivatives.

A bulk heterojunction (BHJ) organic solar cell comprising a conjugated polymer and fullerene has been drawing much attention in the field of solar cells because it is inexpensive, flexible and can be applied to the manufacture of various devices. In general, a polymer organic solar cell uses a blend of a polythiophene-based material as an electron donor and a fullerene derivative as an electron acceptor in an active layer. Recently, an example of improving efficiency by using a low band gap polymer as the electron donor material and using fullerene as the electron acceptor material was reported [Thin Solid Films, vol. 511, 371-376, 2006; G. Adamopoulos, Journal of the American Chemical Society, 130, pp 6444, 2008, Wudl]. Further, the efficiency has been improved by controlling morphology of the donor and acceptor materials in a bulk heterojunction system through use of an additive and various solvents and heat treatment.

A rod-coil block copolymer is reported to form a unique arrangement via a self-assembly nanostructure. Thus, a rod-coil block copolymer where a conjugated polymer is introduced into a rod block may ensure an optimized donor-acceptor morphology in the active layer of an organic solar cell.

A rod-coil block copolymer wherein the conjugated polymer polythiophene is a rod block and polystyrene is a coil block was synthesized via living radical polymerization and its nanofibrillar structure has been described, for example in US Patent Publication No. 2008/0319131; Macromolecules, 2007, 40(14), pp 4733-4735, McCullough. Although synthesis of donor-acceptor rod-coil block copolymers comprising fullerene was reported recently, there are many difficulties in synthesis or purification processes. Moreover, a nanofibrillar structure of a donor-acceptor rod-coil block copolymer comprising fullerene has not been described.

Recently, a donor-acceptor block copolymer was synthesized via ring-opening metathesis polymerization and it was reported that the copolymer may be added to an active layer of an organic solar cell comprising polythiophene and fullerene to control morphology [Advanced Materials, 2006, 18, pp 206. Fréchet]. More recently, the inventors of the present invention synthesized a donor-acceptor block copolymer soluble in an organic solvent via reversible addition-fragmentation chain transfer (RAFT) polymerization and reported an improved efficiency attained by adding a small amount of the copolymer in an active layer of an organic solar cell along with its nanofibrillar structure [Journal of Materials Chemistry, 2009, 19, 5416. Wudl, incorporated by reference in its entirety herein].

However, the copolymer synthesis that has been described requires a multiple step synthesis route and an expensive ruthenium-based catalyst for the ring-opening metathesis polymerization. Moreover, a precise control of proportion of the blocks is required to suitably prepare a material soluble in an organic solvent. Further, the block copolymer synthesis reported by the inventors of the present invention requires synthesis via several routes for the synthesis of long-chain olefinic monomers. Since the long-chain olefinic monomer introduced to improve solubility in an organic solvent is a non-conducting material, it has an adverse effect on the charge mobility.

The above information disclosed in this the Background section is only for enhancement of understanding of the background of the invention and therefore it may contain information that does not form the prior art that is already known in this country to a person of ordinary skill in the art.

### SUMMARY

The present invention is based, in part, on the finding by the present inventors, that when they synthesized a donor-acceptor rod-coil diblock copolymer in which a nitrogen bridge is introduced into fullerene via reversible addition-fragmentation chain transfer (RAFT) polymerization improved from Grignard metathesis (GRIM) and McCullough's method, they found out that the resulting donor-acceptor rod-coil diblock copolymer has a nanofibrillar structure and may improve device efficiency and stability when added to an active layer of a bulk heterojunction organic solar cell comprising polythiophene and fullerene as a compatibilizing agent.

Accordingly, an embodiment of the present invention is directed to providing a compatibilizing agent that can be used in an active layer of a bulk heterojunction organic solar cell comprising polythiophene and fullerene and a method for synthesizing the same.

In a preferred aspect, the present invention provides a donor-acceptor rod-coil diblock copolymer represented by Chemical Formula 1:

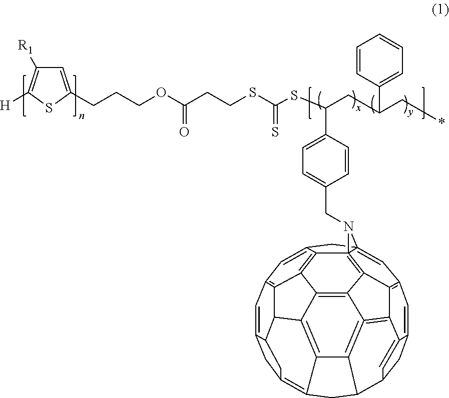

wherein R₁ is a hexyl group; and n, x and y respectively represent a molar ratio of each unit, wherein n is 10 to 30 mol %, x is 10 to 30 mol % and y is 50 to 80 mol %, with the proviso that the sum of (x+y+n) is 100 mol %.

In another general aspect, the present invention provides a method for synthesizing a donor-acceptor rod-coil diblock copolymer, including:

reacting a poly(3-hexylthiophene)-based RAFT agent represented by Chemical Formula 2 with vinylbenzyl chloride and styrene via RAFT polymerization to synthesize a rod-coil copolymer:

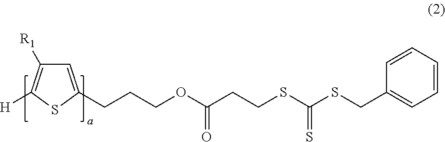

wherein R₁ is a hexyl group and a is an integer from 40 to 200;

reacting the rod-coil copolymer with sodium azide (NaN₃) to synthesize a rod-coil block copolymer having an azide group; and

reacting the rod-coil block copolymer having an azide group with fullerene via 1,3-dipolar cycloaddition to synthesize a donor-acceptor rod-coil diblock copolymer with a nitrogen bridge introduced into fullerene, which is represented by Chemical Formula 1:

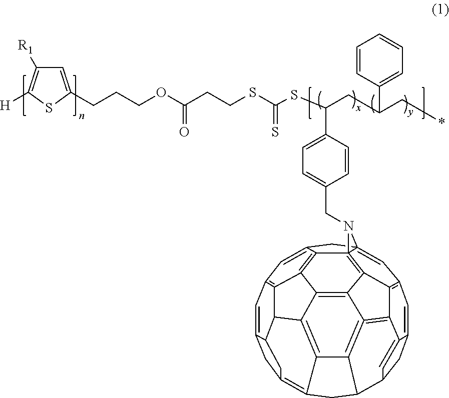

wherein R₁ is a hexyl group; and n, x and y respectively represent a molar ratio of each unit, wherein n is 10 to 30 mol %, x is 10 to 30 mol % and y is 50 to 80 mol %, with the proviso that the sum of (x+y+n) is 100 mol %.

According to preferred embodiments, the donor-acceptor rod-coil diblock copolymer of the present invention has a nanofibrillar structure and preferably includes both the polythiophene acting as an electron donor and the fullerene derivative acting as an electron acceptor. Therefore, if added to an active layer of a bulk heterojunction organic solar cell comprising polythiophene and fullerene, especially poly(3-hexylthiophene) (P3HT) and [6,6]-phenyl-C₆₁-butyric acid methyl ester (PCBM), as a compatibilizing agent, it can suitably improve efficiency and stability of the solar cell.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other objects, features and advantages of the present invention will become apparent from the following description of preferred embodiments given in conjunction with the accompanying drawings, in which:

FIG. 1 schematically shows a process of synthesizing a donor-acceptor rod-coil diblock copolymer for an organic solar cell according to the present invention;

FIG. 2 shows thermogravimetric analysis (TGA) results of P3HT-b-P(St₈₉BCl₁₁) and P3HT-b-P(St₈₉BAz₁₁)-C₆₀ under nitrogen atmosphere;

FIG. 3 shows UV absorption spectra of P3HT-b-P(St₈₉BCl₁₁) and P3HT-b-P(St₈₉BAz₁₁)-C₆₀ in chloroform solution;

FIG. 4 shows a tapping mode atomic force micrograph (TMAFM) of a film surface formed by spin coating a donor-acceptor rod-coil block copolymer for an organic solar cell of the present invention dissolved in chlorobenzene (500 nm×500 nm);

FIG. 5 shows a TMAFM of a film phase formed by spin coating a donor-acceptor rod-coil block copolymer for an organic solar cell of the present invention dissolved in chlorobenzene (500 nm×500 nm);

FIG. 6 shows a configuration of bulk heterojunction organic solar cells manufactured in Comparative Example and Examples 2 to 4;

FIG. 7 shows a current-voltage characteristic of a solar cell depending on the content of a donor-acceptor rod-coil diblock copolymer of the present invention in an active layer of the bulk heterojunction organic solar cell comprising polythiophene and fullerene; and

FIG. 8 shows a thermal stability analysis result of an organic solar cell comprising 10% of a donor-acceptor rod-coil block copolymer of the present invention in an active layer based on the weight of poly(3-hexylthiophene) (Bars denote 95% confidence interval.).

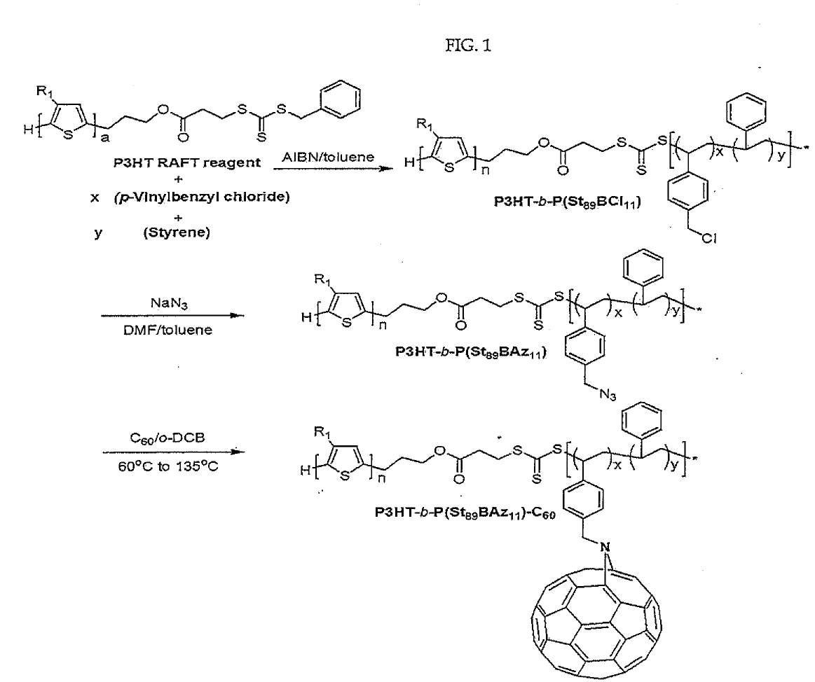

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF EMBODIMENTS

As described herein, the present invention includes a donor-acceptor rod-coil diblock copolymer represented by Chemical Formula 1:

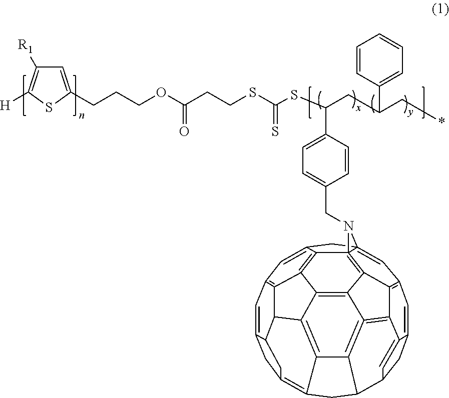

wherein R₁ is a hexyl group; and n, x and y respectively represent a molar ratio of each unit, wherein n is 10 to 30 mol %, x is 10 to 30 mol % and y is 50 to 80 mol %, with the proviso that the sum of (x+y+n) is 100 mol %.

In another aspect, the present invention features a method for synthesizing a donor-acceptor rod-coil diblock copolymer, comprising reacting a poly(3-hexylthiophene)-based reversible addition-fragmentation chain transfer (RAFT) agent represented by Chemical Formula 2 with vinylbenzyl chloride and styrene via reversible addition-fragmentation chain transfer (RAFT) polymerization to synthesize a rod-coil copolymer:

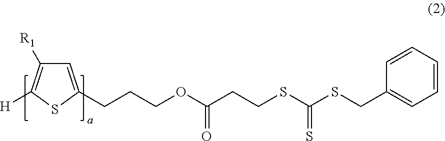

wherein R₁ is a hexyl group and a is an integer from 40 to 200; reacting the rod-coil copolymer with sodium azide (NaN₃) to synthesize a rod-coil block copolymer having an azide group; and reacting the rod-coil block copolymer having an azide group with fullerene via 1,3-dipolar cycloaddition to synthesize a donor-acceptor rod-coil diblock copolymer with a nitrogen bridge introduced into fullerene, which is represented by Chemical Formula 1:

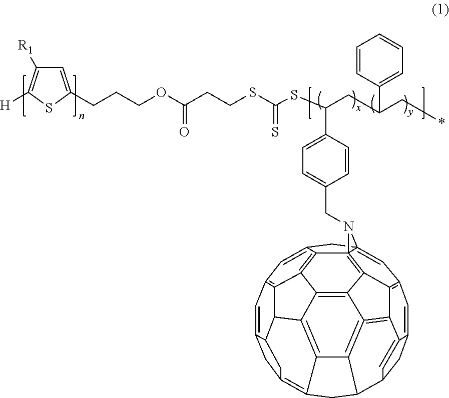

wherein R₁ is a hexyl group; and n, x and y respectively represent a molar ratio of each unit, wherein n is 10 to 30 mol %, x is 10 to 30 mol % and y is 50 to 80 mol %, with the proviso that the sum of (x+y+n) is 100 mol %.

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments.

As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings.

As described herein, the present invention provides a donor-acceptor rod-coil diblock copolymer that can preferably be used in a bulk heterojunction organic solar cell comprising polythiophene and fullerene as a compatibilizing agent.

According to certain exemplary embodiments, the donor-acceptor rod-coil diblock copolymer of the present invention is represented by Chemical Formula 1:

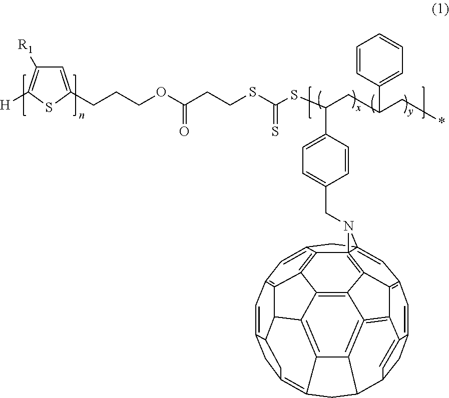

According to further exemplary embodiments, in Chemical Formula 1, R₁ is a hexyl group; and n, x and y respectively represent a molar ratio of each unit, wherein n is 10 to 30 mol %, x is 10 to 30 mol % and y is 50 to 80 mol %, with the proviso that the sum of (x+y+n) is 100 mol %.

In further exemplary embodiments, if x is outside the aforesaid range, a solubility problem may occur. In other further exemplary embodiments, if y is outside the aforesaid range, the donor-acceptor rod-coil diblock copolymer may not serve as a compatibilizing agent. In other further exemplary embodiments, if n is too small, the donor property may be problematic, and if it is too large, a solubility problem may occur. Accordingly, the aforesaid ranges are preferred.

In other further preferred embodiments, in a bulk heterojunction solar cell comprising poly(3-hexylthiophene) (P3HT) and [6,6]-phenyl-C₆₁-butyric acid methyl ester (PCBM), P3HT and PCBM are immiscible with each other. Preferably, improvement of the miscibility of P3HT and PCBM may result in increased contact area between the two substances and, accordingly, improved efficiency of the solar cell. Accordingly, the block copolymer of the present invention having both P3HT and fullerene units may act as a compatibilizing agent in a system comprising the two materials (P3HT and PCBM) to suitably increase the miscibility.

In other certain preferred embodiments, the present invention also provides a method for synthesizing the donor-acceptor rod-coil diblock copolymer represented by Chemical Formula 1.

In a preferred embodiment, a poly(3-hexylthiophene)-based reversible addition-fragmentation chain transfer (RAFT) agent represented by Chemical Formula 2 is reacted with vinylbenzyl chloride and styrene via RAFT polymerization to synthesize a rod-coil copolymer:

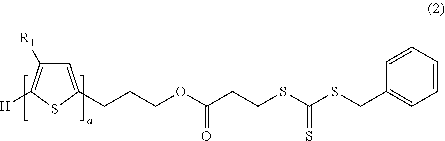

wherein R₁ is a hexyl group and a is an integer from 40 to 200.

Preferably, the RAFT agent may be synthesized from a modified Grignard metathesis (GRIM) and McCullough's method. First, poly(3-hexylthiophene) having a terminal allyl group is synthesized via GRIM reaction in the presence of an i-PrMgCl.LiCl/Ni catalyst. Then, the terminal group is converted to an OH group via polymerization. Preferably, the poly(3-hexylthiophene) having the OH terminal group is suitably reacted with 3-benzylsulfanylthiocarbonylsulfanylpropionic acid chloride to synthesize the compound represented by Chemical Formula 2. Preferably, vinylbenzyl chloride is used as a coil block, as a precursor for addition of an azide group. In a further preferred embodiment, styrene is suitably introduced as a non-reacting group in order to suitably improve solubility of the copolymer in an organic solvent and to suitably improve degree of freedom of a fullerene derivative which will be introduced to the polymer main chain. Preferably, after the P3HT-based RAFT agent, p-vinylbenzyl chloride and styrene are suitably dissolved in an organic solvent along with an initiator, the mixture is reacted at 65 to 95° C. under inert gas atmosphere to synthesize the rod-coil copolymer. In certain preferred embodiments, the initiator may be azobisisobutyronitrile (AIBN) and the organic solvent may preferably be toluene, chlorobenzene or dichlorobenzene. According to certain preferred embodiments, the inert gas is used to suitably prevent termination of polymerization. In further preferred embodiments, argon or nitrogen gas may be used. If the reaction temperature is too low, reaction rate may decrease. And, if the reaction temperature is too high, it may be difficult to control the degree of polymerization distribution. Accordingly, the aforesaid reaction temperature range is preferred. In further preferred embodiments, the synthesized rod-coil copolymer [P3HT-b-P(St₈₉BCl₁₁), wherein BCl is benzyl chloride] may be precipitated by adding methanol and then separated and recovered.

According to further preferred embodiments, the rod-coil copolymer is suitably reacted with sodium azide (NaN₃) to synthesize a rod-coil block copolymer having an azide group.

Preferably, the rod-coil block copolymer (P3HT-b-P(St₈₉BCl₁₁)) synthesized above is reacted with sodium azide to substitute the chlorine atom of the rod-coil block copolymer with an azide group. In preferred exemplary embodiments, this reaction is performed by dissolving and stirring the reactants in a dual organic solvent of toluene and dimethylformamide (DMF). Accordingly, the thus produced rod-coil block copolymer having an azide group [P3HT-b-P(St₈₉BAz₁₁), wherein BAz is benzyl azide] may be precipitated by adding methanol and then separated and recovered.

In a further embodiment, the rod-coil block copolymer having an azide group is reacted with fullerene via 1,3-dipolar cycloaddition to synthesize a donor-acceptor rod-coil diblock copolymer with a nitrogen bridge introduced into fullerene, which is represented by Chemical Formula 1.

Compared with conventional PCBM, nitrogen-bridged PCBM is reported to be more favorable in electron mobility. Preferably, the synthesis to introduce the nitrogen bridge to fullerene may be suitably performed through 1,3-dipolar cycloaddition of fullerene and the azide group. In certain exemplary embodiments, the rod-coil block copolymer having an azide group (P3HT-b-P(St₈₉BAz₁₁)) and fullerene (C₆₀) are suitably dissolved in an organic solvent and then reacted under inert gas atmosphere. Preferably, the organic solvent may be o-dichlorobenzene (o-DCB) or chlorobenzene, and the inert gas may be argon or nitrogen gas, as described earlier. In certain exemplary embodiments, a preferred reaction temperature is 60 to 130° C. If the reaction temperature is too low, reaction rate may decrease. Meanwhile, if the reaction temperature is too high, a crosslinking problem may occur. Accordingly, the thus produced donor-acceptor rod-coil diblock copolymer (P3HT-b-P(St₈₉BAz₁₁)-C₆₀) may be suitably precipitated by adding methanol and then separated and recovered. The resulting polymer has good solubility in chloroform, toluene, or the like.

Since the donor-acceptor rod-coil diblock copolymer according to the present invention has a nanofibrillar structure and includes both the electron donor and acceptors of a bulk heterojunction organic solar cell comprising polythiophene and fullerene, it may be useful in an active layer of the solar cell as a compatibilizing agent.

### EXAMPLES

Examples and experiments will now be described. The following examples and experiments are for illustrative purposes only and not intended to limit the scope of this disclosure.

### Preparation Example

### Preparation of RAFT Agent

Synthesis of Poly(3-Hexylthiophene) Having Terminal allyl Group

2,5-Dibromo-3-hexylthiophene (5 g, 15.32 mmol), 1,3-bis(diphenylphosphino)propane dichloronickel (II) (Ni(dppp)Cl₂, 0.248 g, 510 mmol) and anhydrous THF (tetrahydrofuran) solvent were added to a dried flask, and then purged with argon gas. Then, 1 M i-PrMgCl.LiCl solution (15.5 mL, 15.5 mmol) was added. Polymerization was performed at 0° C. for 1 hour. For introduction of terminal group, 1 M allylmagnesium bromide solution (10 mL, 10 mmol) was added. 30 minutes later, methanol was added to precipitate the product. Soxhlet extraction followed by purification yielded a poly(3-hexylthiophene) polymer having a terminal allyl group [GPC analysis: Mn=8,320 g/mol, Mw=9,250 g/mol, polydispersity index (PDI)=1.1 (based on PS)].

Synthesis of Poly(3-Hexylthiophene) Having Terminal Hydroxyl Group

Thus synthesized poly(3-hexylthiophene) having a terminal allyl group was dissolved in anhydrous THF and then purged with argon. Then, after adding 1 M 9-borabicyclo(3.3.1)nonane (9-BBN) solution (4 mL), reaction was performed at 40° C. for 24 hours. After adding 6 M NaOH solution, 33% hydrogen peroxide solution (2 mL) was added 15 minutes later. Soxhlet extraction followed by purification yielded poly(3-hexylthiophene) having a terminal hydroxyl group.

Synthesis of RAFT Agent

The poly(3-hexylthiophene) having a terminal hydroxyl group was dissolved in anhydrous THF and then purged with argon. Then, after adding 3-benzylsulfanylthiocarbonylsulfanylpropionic acid chloride (0.5 g) and triethylamine (3 mL), the mixture was allowed to stand at 40° C. for 24 hours and then methanol was added to precipitate the product. Soxhlet extraction followed by purification yielded a RAFT agent represented by Chemical Formula 2.

### Example 1

### Preparation of Donor-Acceptor Rod-Coil Diblock Copolymer

Synthesis of P3HT-b-P(St₈₉BCl₁₁)

The poly(3-hexylthiophene) having a terminal trithiocarbonate group synthesized above (P3HT, 0.1 g, 12 μmol), as a macro-RAFT agent, azobisisobutyronitrile (AIBN, 0.75 mg, 4.5 μmol), as an initiator, and anhydrous toluene (2.5 mL) were added to a Schlenk flask that had been purged with argon gas for 15 minutes. To the resulting mixture solution was added a mixture of styrene (2.2 g, 21.1 mmol), p-vinylbenzyl chloride (0.407 g, 2.67 mmol) and anhydrous toluene (3 mL). After removing gas in the flask through 3 freeze-pump-thaw cycles, dried argon gas was injected. Then, the flask was immersed in an oil bath of 70 to 75° C. for 24 hours to prepare a polymer solution. After precipitating the polymer solution by adding methanol (200 mL), the precipitate was recovered centrifugation. The recovered precipitate was dissolved in ethyl acetate solution at 70° C. Undissolved, unreacted P3HT was filtered off and ethyl acetate was evaporated from the filtrate to recover the resulting powder, which was dissolved again in THF. Precipitation with methanol followed by centrifugation, washing and drying in vacuum yielded a rod-coil block copolymer (P3HT-b-P(St₈₉BCl₁₁)) as reddish solid. NMR analysis of the copolymer revealed P3HT:PSt:PBCl=10:76:14 (mol %) [¹H NMR (CDCl₃, 500 MHz): d ppm 7.20-6.87 (br, m), 6.69-6.30 (br, m), 4.52 (br, m), 2.83 (br, m), 2.10-1.67 (br, m), 1.65-1.15 (br, m), 0.93 (br, m); GPC analysis: Mn=18,910 g/mol, Mw=29,680 kg/mol, PDI=1.57 (based on PS)].

Synthesis of P3HT-b-P(St₈₉BAz₁₁)

P3HT-b-P(St₈₉BCl₁₁) (350 g) and sodium azide (0.91 g, 13.99 mmol) were added to a mixture solution of anhydrous dimethylformamide (DMF, 25 mL) and anhydrous toluene (25 mL) and then stirred for 12 hours under reflux. The mixture was added to a solution (200 mL) of methanol and water of the same volume and then the resulting solid polymer was recovered by filtering. The recovered polymer was dissolved in THF. After precipitation by adding methanol (200 mL), the precipitate was recovered by centrifugation. Drying in vacuum yielded a rod-coil block copolymer having an azide group (P3HT-b-P(St₈₉BAz₁₁)) as reddish solid [¹H NMR (CDCl₃, 200 MHz): d ppm 7.21-6.87 (br, m), 6.72-6.32 (br, m), 4.22 (br, m), 2.81 (br, m), 2.01-1.65 (br, m), 1.63-1.11 (br, m), 0.92 (br, m)].

Synthesis of P3HT-b-P(St₈₉BAz₁₁)-C₆₀

P3HT-b-P(St₈₉BAz₁₁) (300 mg), fullerene (0.20 g, 0.27 mmol) and anhydrous o-dichlorobenzene (DCB, 200 mL) were added to a Schlenk flask and gas in the flask was removed via argon bubbling for 30 minutes. Then, the mixture remaining in the flask was stirred at 60° C. for 2 days under argon atmosphere. Then, after heating to 130° C. and keeping at the temperature for 12 hours, the resulting mixture was concentrated under reduced pressure. After adding the mixture to methanol (200 mL), the resulting precipitate was recovered, dissolved in THF (500 mL), and then filtered. THF was evaporated from the filtrate and the residue was washed twice with hexane. The crude product was dissolved again in THF (500 mL) and filtered through a micromembrane filter (0.45 mm). After evaporating THF from the filtrate, thus obtained solid was dissolved in a small quantity of o-DCB solution and then precipitated in hot hexane solution. While monitoring through thin layer chromatography (TLC), unreacted C₆₀ was repeatedly dissolved in a small quantity of o-DCB solution and then precipitated in hot hexane solution. The resulting product was recovered and dried. A donor-acceptor rod-coil diblock copolymer (P3HT-b-P(St₈₉BAz₁₁)-C₆₀) was obtained as reddish brown solid [¹H NMR (CDCl₃, 500 MHz): d ppm 7.45 (br, m), 7.25-6.83 (br, m), 6.80-6.25 (br, m), 2.83 (br, m), 2.15-1.11 (br, m), 0.92 (br, m)].

### Examples 2-4 and Comparative Example

### Preparation of Bulk Heterojunction Organic Solar Cell

A glass substrate coated with indium tin oxide (ITO) was washed with a cleaning solution and then dried in an oven for 12 hours after ultrasonication in a mixture solution of acetone and isopropyl alcohol. Then, an aqueous solution of poly(3,4-ethylenedioxythiophene) poly(styrenesulfonate) (PEDOT:PSS, Baytron PH) was spin cast on the ITO film of the dried substrate to form a 40 nm-thick film. After drying at 150° C. for 10 minutes, a solution wherein the donor-acceptor rod-coil diblock copolymer prepared in Example 1 was added to 2 wt % P3HT:PCBM (weight ratio=1:0.8) dissolved in o-dichlorobenzene so that the weight ratio of P3HT:P3HT-b-P(St₈₉BAz₁₁)-C₆₀ was 1:0-0.5 spin cast on the PEDOT:PSS film of the substrate to form a 40 nm-thick active layer film. After drying at 150° C. for 10 minutes, the substrate was put in a chamber and a 100 nm-thick aluminum electrode was deposited on the active layer under a reduced pressure condition of 10⁻⁷ torr. Specific contents of the donor-acceptor rod-coil diblock copolymer were the same as given in Table 1.

TABLE 1

| | Weight ratio | | |
|---|---|---|---|
| | P3HT | PCBM | P3HT-b-P(St₈₉BAz₁₁)-C₆₀ |
| Comparative | 1 | 0.8 | 0 |
| Example | | | |
| Example 2 | 1 | 0.8 | 0.1 |
| Example 3 | 1 | 0.8 | 0.2 |
| Example 4 | 1 | 0.8 | 0.5 |

Physical Property Test

1) Thermogravimetric Analysis (TGA)

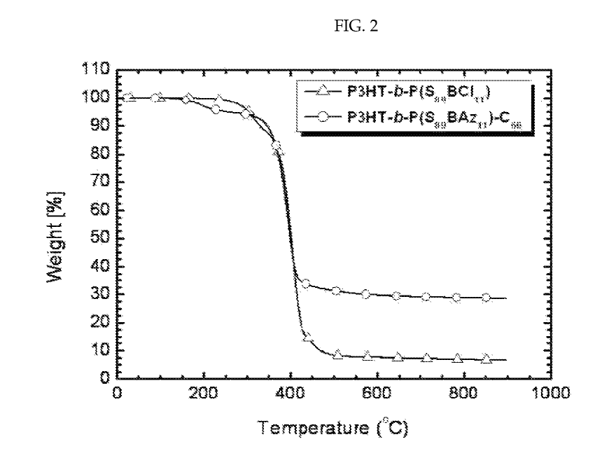

Thermogravimetric analysis was performed under nitrogen atmosphere on P3HT-b-P(St₈₉BCl₁₁) and P3HT-b-P(St₈₉BAz₁₁)-C₆₀ prepared in Example 1 using a thermogravimetric analyzer (Model: Q200). Heating rate was 10° C./min. As shown in FIG. 2, P3HT-b-P(St₈₉BCl₁₁) was completely decomposed at 550° C., whereas about 30% of P3HT-b-P(St₈₉BAz₁₁)-C₆₀ remained. This confirms that excess fullerene was introduced to P3HT-b-P(St₈₉BAz₁₁)-C₆₀.

2) UV Absorption

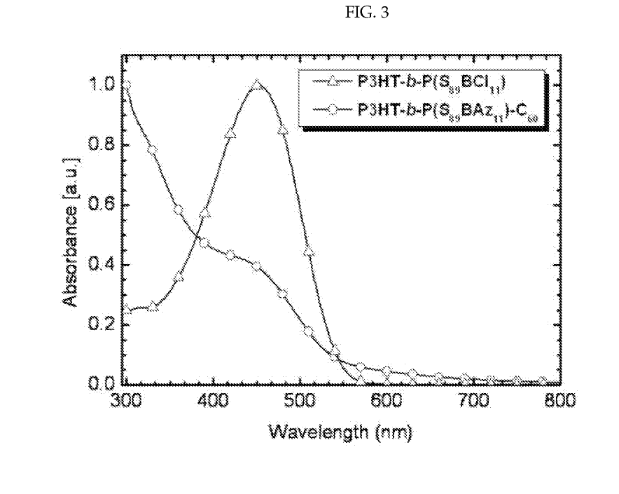

UV absorption spectra of P3HT-b-P(St₈₉BCl₁₁) and P3HT-b-P(St₈₉BAz₁₁)-C₆₀ were obtained in chloroform solution. As shown in FIG. 3, P3HT-b-P(St₈₉BAz₁₁)-C₆₀ showed absorption bands at 330 nm and 453 nm. The band at the longer wavelength is due to the absorption of P3HT, and that at the shorter wavelength is due to the absorption of fullerene.

3) Solid Surface Analysis

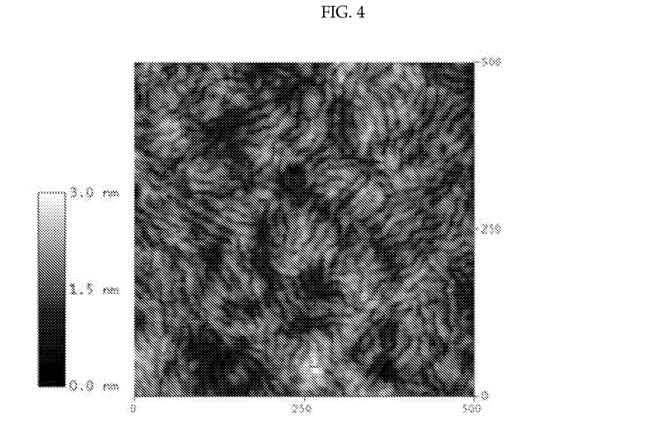

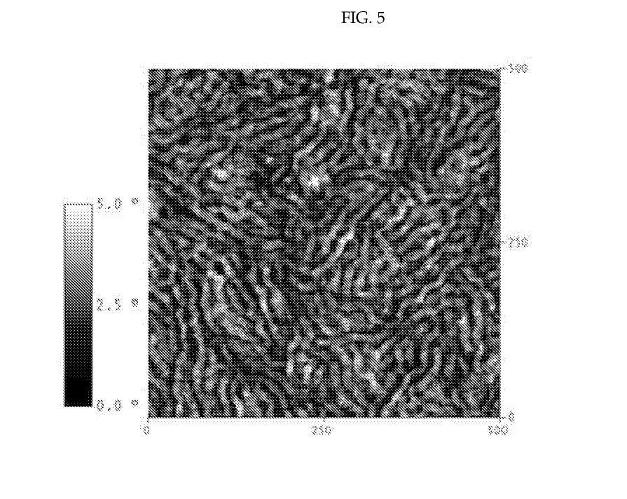

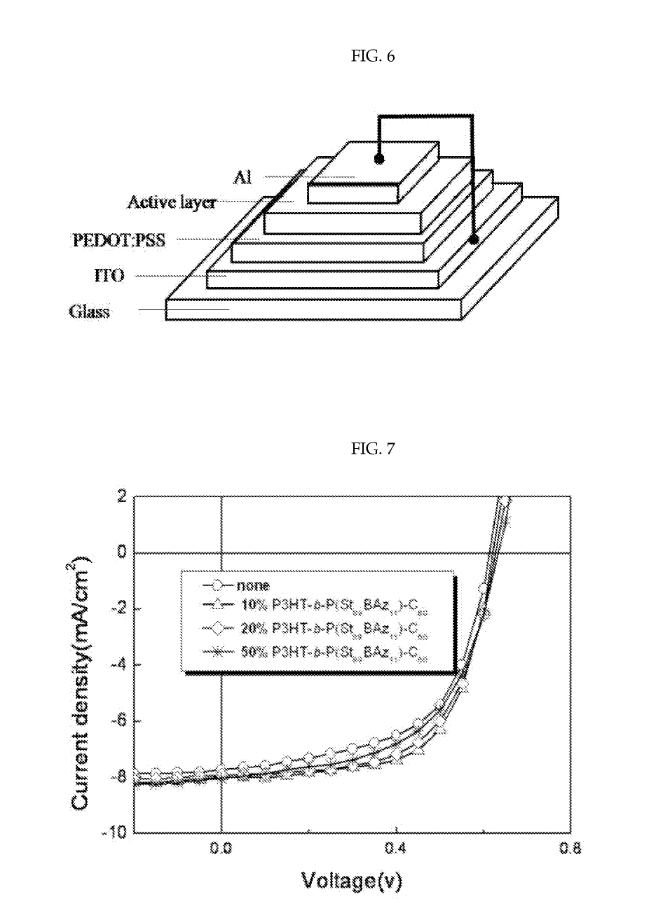

Surface of P3HT-b-P(St₈₉BAz₁₁)-C₆₀ was analyzed by tapping mode atomic force microscopy (TMAFM). As shown in FIGS. 4 and 5, a clear nanofibrillar structure was observed.

4) Efficiency of Organic Solar Cell

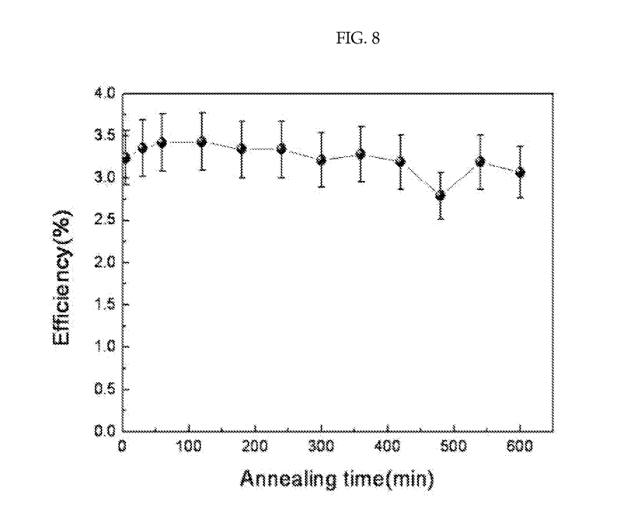

The efficiency of the donor-acceptor rod-coil diblock copolymer as a compatibilizing agent in a bulk heterojunction solar cell comprising P3HT and PCBM is highly dependent on the concentration of the compatibilizing agent added to the immiscible P3HT and PCBM. The power conversion efficiency (PCE) of the organic solar cells manufactured in Comparative Example and Examples 2-4 was calculated from open circuit voltage (V_{OC}), short circuit current density (J_{SC}) and fill factor (FF) measured using a solar simulator equipped with Keithley 2635A. The P3HT:PCBM solar cell of Comparative Example had been heat treated at 150° C. to improve efficiency. All measurements were made at a light intensity of 100 mW/cm² using an AM 1.5 G lamp. The result is presented in Table 2 and FIG. 7.

TABLE 2

| | P3HT:PCBM: P3HT-b-P(St₈₉BAz₁₁)-C₆₀ | J_{SC} | | | PCE |
|---|---|---|---|---|---|
| | (weight ratio) | (mA/cm²) | V_{OC} (V) | FF | (ηe) (%) |
| Comparative | 1:0.8:0 | 7.74 | 0.613 | 0.58 | 2.75 |
| Example | | | | | |
| Example 2 | 1:0.8:0.1 | 7.96 | 0.621 | 0.64 | 3.16 |
| Example 3 | 1:0.8:0.2 | 7.92 | 0.627 | 0.61 | 3.04 |
| Example 4 | 1:0.8:0.5 | 8.03 | 0.634 | 0.56 | 2.86 |

For the solar cell of Comparative Example, V_{OC} was 0.61 V, J_{SC} was 7.74 mA/cm², and FF was 58%, and PCE was calculated as 2.75%. The solar cell of Example 2, wherein 10 wt % of P3HT-b-P(St₈₉BAz₁₁)-C₆₀ was added based on the weight of P3HT in the active layer of P3HT:PCBM, exhibited highest at energy efficiency of 3.16%. This corresponds to approximately 15% improvement as compared to the P3HT:PCBM solar cell of Comparative Example. This results from increased surface area which is due to the P3HT-b-P(St₈₉BAz₁₁)-C₆₀ effectively acting as a compatibilizing agent in the P3HT:PCBM layer. The addition of P3HT-b-P(St₈₉BAz₁₁)-C₆₀ in excess resulted in degrease of efficiency. This result may be due to the aggressive phase segregation of the block copolymer in the P3HT:PCBM layer.

5) Thermal Stability of Organic Solar Cell

The solar cell of Example 2 which exhibited the highest efficiency was heat treated at 150° C. and the change in PCE with time was monitored. As shown in FIG. 8, the efficiency was maintained even after 10 hours without decrease. This is because P3HT-b-P(St₈₉BAz₁₁)-C₆₀ prevented the aggregation of the P3HT and PCBM units caused by heating.

While the present invention has been described with respect to the specific embodiments, it will be apparent to those skilled in the art that various changes and modifications may be made without departing from the spirit and scope of the invention as defined in the following claims.

What is claimed is:

1. A donor-acceptor rod-coil diblock copolymer represented by Chemical Formula 1: 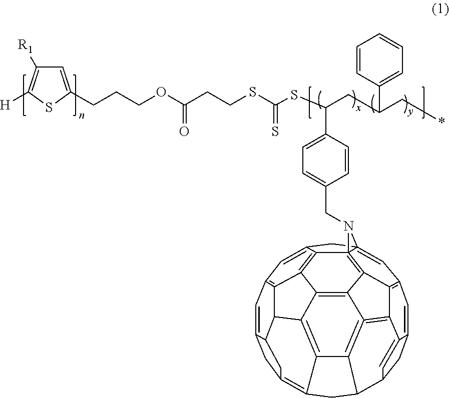
wherein R₁ is a hexyl group; and n, x and y respectively represent a molar ratio of each unit, wherein n is 10 to 30 mol %, x is 10 to 30 mol % and y is 50 to 80 mol %, with the proviso that the sum of (x+y+n) is 100 mol %.

2. A method for synthesizing a donor-acceptor rod-coil diblock copolymer, comprising:
reacting a poly(3-hexylthiophene)-based reversible addition-fragmentation chain transfer (RAFT) agent represented by Chemical Formula 2 with vinylbenzyl chloride and styrene via reversible addition-fragmentation chain transfer (RAFT) polymerization to synthesize a rod-coil copolymer: 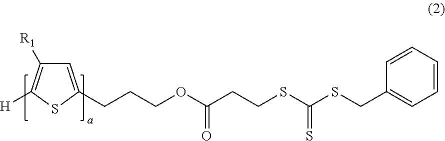
wherein R₁ is a hexyl group and a is an integer from 40 to 200;
reacting the rod-coil copolymer with sodium azide (NaN₃) to synthesize a rod-coil block copolymer having an azide group; and
reacting the rod-coil block copolymer having an azide group with fullerene via 1,3-dipolar cycloaddition to synthesize a donor-acceptor rod-coil diblock copolymer with a nitrogen bridge introduced into fullerene, which is represented by Chemical Formula 1: 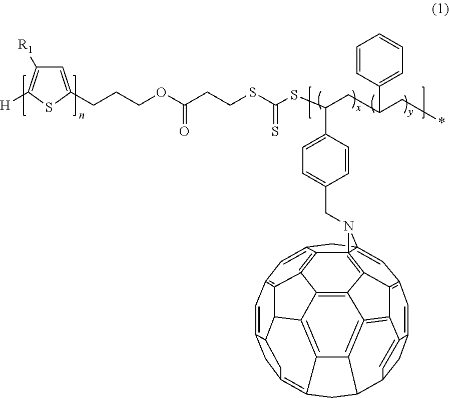
wherein R₁ is a hexyl group; and n, x and y respectively represent a molar ratio of each unit, wherein n is 10 to 30 mol %, x is 10 to 30 mol % and y is 50 to 80 mol %, with the proviso that the sum of (x+y+n) is 100 mol %.

3. An organic solar cell comprising the donor-acceptor rod-coil diblock copolymer according to claim 1 in a bulk heterojunction active layer of polythiophene and fullerene.
